(19) United States
(12) Patent Application Publication
(10) Pub. No.: US 2007/0213196 A1
(43) Pub. Date: Sep. 13, 2007

(54) High transmission grey glass composition with reduced iron

(76) Inventors: James V. Jones, Nashville, TN (US); Edward N. Boulos, Troy, MI (US)

Correspondence Address: AUTOMOTIVE COMPONENTS HOLDINGS LLC;C/O MACMILLAN, SOBANSKI & TODD, LLC, ONE MARITIME PLAZA, FIFTH FLOOR, 720 WATER STREET, TOLEDO, OH, 43604-1853, US

(21) Appl. No.: 11/374,254

(22) Filed: Mar. 13, 2006

(51) Int. Cl. C03C 3/087

(52) U.S. Cl. 501/70; 501/71

(57) ABSTRACT

A glass composition has a base and a colorant. The composition of the base is 68 to 75% SiO₂, 10 to 18 wt. % Na₂O, 5 to 15 wt. % CaO, 0 to 10 wt. % MgO, 0 to 5 wt. % Al₂O₃, and 0 to 5 wt. % K₂O, where CaO+MgO is 6 to 15 wt. % and Na₂O+K₂O is 10 to 20 wt. % is provided. The composition of the colorants comprises 0.22 to 0.36 wt. % Fe₂O₃, 0.10-0.18 wt. % FeO, 0.1 to 0.5 wt. % MnO₂, 1.5 to 13 ppm selenium, and 0 to 15 ppm Cobalt. A redox ratio of the weight of FeO to the total weight of iron is in a range of about 0.35 to up to less than about 0.60. The glass has spectral properties at a control thickness of 4.0 mm of 74 -77% transmittance using illuminant A, 57-65% ultraviolet transmittance, 30-46% infrared transmittance and 50-61 % total solar energy transmittance. The color of glass of the invention using illuminant C with a 2° observer is a parallelogram bounded by the following x and y chromaticity coordinates: (0.304, 0.314); (0.3075, 0.3205); (0.3065, 0.323); and (0.303, 0.317). The color space renders the glass color a neutral grey.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to a composition for automotive and architectural glass, and, more specifically, to high transmittance grey glass with high infrared absorption that is made using a process that provides an increased proportion of iron in the reduced form.

Window-type glass is manufactured mainly for automotive applications (e.g., windshields and backlights) and architectural applications (e.g., windows and doors of buildings and homes). Although many of the desired properties for automotive and architectural glass are very similar, the glass compositions typically used in each field of application have been quite different. It would be extremely advantageous to improve the infrared absorption of glass products while maintaining a high level of visible transmission and to also have a good absorption in the ultraviolet portion of the spectrum.

Automotive glass must provide a very good transmittance of visible light while significantly blocking infrared light. These demands have typically been met using a tinted glass having a green coloration. However, a neutral glass color would be desirable to improve styling and avoid the glass color clashing with other portions of the vehicle. Glass for vehicles is typically a laminate having two thin glass plies with a clear plastic interlayer.

Choosing an architectural glass for buildings puts more emphasis on the color of the glass and its physical/mechanical characteristics. Although clear glass is often used, it would be desirable in many cases to utilize a neutral grey color for its aesthetic and optical properties. Various coatings can also be applied to a grey glass in order to obtain other desirable spectral properties (i.e., colors). On the other hand, grey glass compositions already used in architectural applications provide insufficient visible transmittance to satisfy the requirements for an automotive glass. A typical grey architectural glass at 4 mm thickness may provide 55.5% transmittance using illuminant A (LTA) with a 40.5% ultraviolet transmittance, a 57% infrared transmittance, and a 57% total solar energy transmittance. Regulations require an automotive glass (except in trucks behind the B-pillar) to provide a 70% LTA. Therefore, conventional grey compositions are unsuitable for automotive use. Moreover, it would be desirable to further decrease the transmittance of ultraviolet which fades fabrics and infrared which otherwise heats a building and raises the costs of air conditioning.

The batch ingredients of a glass composition include some basic ingredients (e.g., sand, soda ash, etc.) together with additives for determining various properties of the glass. One well known additive is iron. Iron oxide exists in two chemical forms in the glass, an oxidized form (Fe₂O₃) which is yellow and a reduced form (FeO) which is blue. Advantageously, the oxidized form of iron oxide absorbs a portion of the ultraviolet light passing through the glass product and the reduced form of iron oxide absorbs a portion of the infrared light passing through the glass product. Under typical furnace firing conditions and batching conditions, when the total iron oxide in the glass product is within the range of about 0.2 to 1.2 wt. % as Fe₂O₃, the iron oxide equilibrium is such that the redox ratio of FeO/total Fe as Fe₂O₃ is about 0.18-0.26.

It is desirable to increase the proportion of reduced iron oxide (FeO) in the glass to improve its infrared absorption. In addition, by shifting the iron oxide away from the oxidized form (Fe₂O₃) the glass will change color from green to blue. In order to achieve a desirably grey coloration, it is necessary to utilize other additives to shift the spectral properties from blue towards grey, preferably in a manner that simultaneously improves the ultraviolet and infrared absorption. U.S. Pat. No. 6,821,918 is an example of one such composition.

One way commonly employed to shift the redox equilibrium of iron oxide in the glass, and hence its UV and IR properties, is by increasing the fuel to the furnace. Increasing the amount of fuel, however, has several undesirable consequences: the combustion heating of the furnace becomes inefficient and requires an air increase or the unburnt fuel will burn in the checker system of the furnace. Excess fuel can also reduce the glass to an amber color that sharply lowers the visible transmittance of the glass product. An amber color arises when the iron reacts with sulfur that has been reduced to form iron sulfide. Amber colored glass containers are normally melted in like manner by using anthracite coal together with iron oxide and sulfate. The amber iron sulfide chromophore, once produced, significantly decreases the visible transmittance of the glass and the glass could not be used where a high transmittance is required. Therefore, there is a need in the glass industry to produce gray or bronze glass that has high transmittance yet having an improved infrared light absorption and an ultra violet absorption.

### SUMMARY OF THE INVENTION

In one aspect of the present invention a grey glass having a base and a colorant is provided. The composition of the base comprises 68 to 75% SiO₂, 10 to 18 wt. % Na₂O, 5 to 15 wt. % CaO, 0 to 10 wt. % MgO, 0 to 5 wt. % Al₂O₃, and 0 to 5 wt. % K₂O, where CaO+MgO is 6 to 15 wt. % and Na₂O+K₂O is 10 to 20 wt. % is provided. The composition of the colorants comprises: 0.22 to 0.36 wt. % Fe₂O₃, 0.10-0.18 wt. % FeO, 0.1 to 0.5 wt. % MnO₂, 1.5 to 13 ppm selenium, and 0 to 15 ppm Cobalt. A redox ratio of the weight of FeO to the total weight of iron is in a range of about 0.35 to up to less than about 0.60 (most preferably in the range from about 0.45 to about 0.55). The foregoing chemistry makes glass that has the following spectral properties at a control thickness of 4.0 mm: 74-77% transmittance using illuminant A, 57-65% ultraviolet transmittance, 30-46% infrared transmittance and 50-61% total solar energy transmittance. The color of glass of the invention using illuminant C with a 2° observer is a parallelogram bounded by the following x and y chromaticity coordinates: (0.304, 0.314); (0.3075, 0.3205); (0.3065, 0.323); and (0.303, 0.317). The color space renders the glass color a neutral grey. Generally, as the quantities of the colorants increase, both the % LTA and % IR transmittance will go down. Similarly, as the glass thickness increases for a given glass composition, the transmittance of the thicker glass will decrease.

The glass composition of the present invention provides good visible transmittance while maintaining a neutral grey appearance and significantly lowering the ultraviolet and infrared transmittance, thereby making the glass desirable for both architectural and automotive applications. It combines some of the attributes of both clear and grey glasses as outlined above while meeting regulatory LTA specifications for all automotive glasses.

### BRIEF DESCRIPTION OF THE DRAWINGS

FIG. 1 is a plot showing the color space of the present invention compared to those of prior art compositions.

### DETAILED DESCRIPTION OF PREFERRED EMBODIMENTS

Flat soda-lime-silica glass, used in the automotive and architectural industries and conveniently made by the float glass process, is generally characterized by the following basic composition, the amounts of the components being based on a weight percentage of the total glass composition:

TABLE I

| Base Glass | |
|---|---|
| Components | Weight % |
| SiO₂ | 68 to 75 |
| Al₂O₃ | 0 to 5 |
| CaO | 5 to 15 |
| MgO | 0 to 10 |
| Na₂O | 10 to 18 |
| K₂O | 0 to 5 |

The grey glass composition of the present invention employs this basic soda-lime-silica glass composition wherein, additionally, CaO+MgO is 6 to 15 wt. % and Na₂O+K₂O is 10 to 20 wt. %. Preferably, SO₃ is present in an amount of 0.03 to 0.20 wt %, and more preferably, 0.03 to 0.10 wt. % in the final glass product. In addition, the grey glass composition consists essentially of the following coloring components: iron oxide, manganese compound, selenium, and optionally cobalt.

The total iron as Fe₂O₃ is present in the invention composition in quantities of 0.22 to 0.36 wt. % Fe₂O₃. Typically, this ingredient is added with the batch ingredients in the oxide form, i.e. Fe₂O₃. The iron oxide incorporated in the composition lowers both the ultraviolet and the infrared transmittance of the glass products. Iron oxide as used in normal commercial production has a redox ratio (defined as equal to the weight of FeO divided by the total iron) in the range of about 0.18-0.26. In contrast, the glass of the present invention has a higher redox ratio in the range of about 0.35 to up to less than about 0.60, with a most preferred range from about 0.45 to about 0.55. As the percent of FeO approaches 60% of the total iron oxide, the iron reacts with sulfate in the glass to produce a deep amber color which would be detrimental. Since sulfates are required to aid in removing gaseous inclusions from the glass in the molten state, the percent of FeO must be maintained in the given range. Care is taken to maintain the high proportion of reduced iron through the copious use of a reductant such as coal or graphite or through the introduction of the iron oxide into the batch in a highly reduced state.

The addition of selenium moves the color of the glass towards bronze and cobalt lowers the dominant wavelength and excitation purity. A desired neutral grey color is obtained by choosing relative amounts of selenium and/or cobalt oxide either through deliberate batch input or from the remnants of a previous product melted in the furnace used to make glass of the invention. Manganese dioxide is used to aid in maintaining the equilibrium of the iron since it acts as an oxidizer and helps to prevent the amber formation.

The glass of the invention is manufactured by one step batch admixing of the components to feed a conventional SIEMENS float glass furnace. Sodium sulfate is mixed in the batch together with anthracite coal or graphite to shift the iron oxide equilibrium toward the reduced form of iron (FeO). Manganese dioxide is necessary in the batch to prevent the formation of the amber iron sulfide and to aid in the retention of the selenium. All of the batch components are mixed together in a single step and then metered into the furnace.

A manganese compound is present in an amount of 0.1 to 0.5 wt. % based on MnO₂ in the glass composition. This manganese compound can be added to the batch glass components in a variety forms, e.g., but not limited to MnO₂, Mn₃O4, MnO, MnCO₃, MnSO₄, MnF₂, or MnCl₂, etc.

Table II discloses example amounts of raw material batch ingredients that are preferably used to form the grey glass compositions according to the present invention.

TABLE II

| Batch Material | Range of Mass (lbs.) |
|---|---|
| Sand | 1000 |
| Soda Ash | 290 to 350 |
| Limestone | 70 to 90 |
| Dolomite | 215 to 260 |
| Salt cake | 2.5 to 11 |
| Rouge (97% Fe₂O₃) | 4.1 to 7.2 |
| Manganese Dioxide | 1.3 to 7.0 |
| Selenium | 0.04 to 0.65 |
| Cobalt Oxide | 0 to 0.03 |
| Anthracite coal | 0.9 to 2.5 |

The anthracite coal can be bought under the trade-name CARBOCITE and is commercially available from the Shamokin Filler Company. Graphite is used as an alternative source of carbon with and without anthracite coal in the following examples. MELITE, a coal slag processed by Calumite Corporation could partially or wholly substitute for rouge in the batch up to about 55 pounds MELITE per 1000 pounds of sand. MELITE has about 80% of the total iron oxide in the reduced form and thus would require less anthracite coal to generate similar spectral properties. The purpose of each of these materials is to shift the iron redox ratio from its normal range of 0.18 to 0.26 up to a higher range from about 0.35 to up to less than about 0.60. Most preferably, the iron redox ratio is in the range of about 0.45 to about 0.55.

The equilibrium reactions that occur in the glass melt which causes a shift in the forms of iron oxide are influenced by the sodium sulfate used as a refining agent and carbon used to react with sodium sulfate at lower furnace temperatures. Generally, increasing the quantity of sodium sulfate in the glass tends to shift the iron oxide equilibrium slightly toward oxidizing. On the other hand, increasing carbon concentration in the glass batch shifts the iron oxide equilibrium toward reducing form of iron. Increasing the amount of manganese oxide shifts the iron oxide equilibrium again towards the oxide form. Another influence on the iron oxide equilibrium is the peak furnace temperature, which when increased will shift the iron oxide slightly toward the reduced state and when lowered will shift the iron oxide back towards the oxidized state.

Melts were made in the laboratory which demonstrate embodiments of this invention using the procedure as follows. Batches were weighed, placed into a glass jar about 2″ high and 2″ inside diameter, and dry mixed for 10 minutes each on a Turbula mixer. The dry batch was placed into an 80% platinum/20% rhodium crucible that stands 2″ tall and has an inside diameter at the top of 2.5″ and is tapered to the base which has an inside diameter of 1.75″. An amount of 4.5 ml. of water is added to the dry batch in the crucible and mixed with a metal spoon. After such preparation, a group of different batches is melted in a gas/air fired furnace at the same time for 1 hour at 2600° F. and each crucible is removed in turn from the furnace and fritted. Fritting the glass involves coating the inside of the platinum/rhodium crucible by rolling the molten glass around the inside of the crucible and then plunging the crucible into cold water. After removing the crucible from the water and draining, the broken glass particles are removed from the sides of the crucible and mechanically mixed inside the crucible. All samples are fritted in like manner and all crucibles are placed back into the furnace for another hour interval at 2600° F. and the fritting procedure is repeated. After the second fritting process, the crucibles are returned to the furnace for 4 hours at 2600° F. Each crucible is removed in turn from the furnace and each molten glass sample is poured into a graphite mold with an inside diameter of 2.5″. Each glass is cooled slowly, labeled, and placed into an annealing furnace where the temperature is quickly raised to 1050° F., held for 2 hours, and then slowly cooled by shutting off the furnace and removing the samples after 14 or more hours. The samples are ground and polished to about 4.0 mm. thickness and subsequently the spectral properties are measured for each sample.

All laboratory melts made with above procedure use a base composition of 100 grams sand, 32.22 grams soda ash, 8.81 grams limestone, 23.09 grams dolomite, 0.25 to 1.1 grams of sodium sulfate, 0.09 to 0.25 grams of CARBOCITE, 2.64 grams of nepheline syenite, and the remainder of the batch includes rouge, manganese dioxide, selenium and optionally cobalt oxide.

Each of the following tables of example glass compositions includes spectral data at 4.0 mm, which is the control thickness. The % LTA is defined to be the % luminance transmittance measured under CIE standard illuminant A. The dominant wavelength and the % excitation purity are measured using CIE standard illuminant C. The % UV is the % ultraviolet transmittance measured between 300 and 400 nanometers and % IR is the % infrared transmittance measured between 750 and 2100 nanometers.

Table III below indicates glass compositions of the instant invention that do not require any cobalt to achieve a neutral grey color with enhanced ultraviolet and infrared absorption. The iron oxide equilibrium is shifted toward the reduced form by using a large amount of anthracite coal. The compositions herein are from melts made with 100% batch. The anthracite coal or other reductant typically must be increased when cullet (broken pieces of recycled glass) is introduced into the batch as occurs in commercial production of glass. If the cullet is not reduced iron cullet as that of the instant invention, then the reductant concentration must be increased to a greater degree. The furnace operating conditions also affect the oxidation or reduction of the iron oxide equilibrium. All of the batch amounts in the tables below are in proportion to 1000 pounds of sand. The spectral properties are all at a corrected thickness of 4.0 mm.

TABLE III

| | Example 1 | Example 2 | Example 3 | Example 4 | Example 5 |
|---|---|---|---|---|---|
| Salt Cake | 2.5 | 5.0 | 5.0 | 10.0 | 5.0 |
| Anthracite | 1.4 | 1.3 | 1.4 | 1.8 | 1.8 |
| Coal | | | | | |
| Wt. % Fe₂O₃ | 0.352 | 0.352 | 0.351 | 0.300 | 0.351 |
| Wt. % FeO | 0.172 | 0.164 | 0.153 | 0.156 | 0.167 |
| Wt. % MnO₂ | 0.15 | 0.15 | 0.15 | 0.45 | 0.15 |
| ppm Se | 1.5 | 2.0 | 2.5 | 1.5 | 2.5 |
| Redox Ratio | 0.488 | 0.467 | 0.435 | 0.520 | 0.476 |
| % LTA | 73.52 | 74.58 | 74.75 | 75.37 | 73.74 |
| % LTC | 74.30 | 75.44 | 75.48 | 76.22 | 74.52 |
| Chrome x | 0.3058 | 0.3052 | 0.3063 | 0.3057 | 0.3059 |
| Chrome y | 0.3211 | 0.3206 | 0.3210 | 0.3216 | 0.3213 |
| Dominant | 505.4 | 501.7 | 506.9 | 506.3 | 506.3 |
| Wavelength | | | | | |
| Excitation | 1.4 | 1.6 | 1.2 | 1.5 | 1.4 |
| Purity, % | | | | | |
| % UV | 57.25 | 57.91 | 57.07 | 58.70 | 57.64 |
| % IR | 30.96 | 32.43 | 34.55 | 33.90 | 31.72 |
| % TSET | 50.36 | 51.69 | 52.88 | 52.75 | 50.87 |

Table IV also does not use any cobalt and some glass compositions use graphite rather than anthracite coal as the reductant to achieve the high proportion of reduced iron oxide.

TABLE IV

| | | | | | Example |
|---|---|---|---|---|---|
| | Example 6 | Example 7 | Example 8 | Example 9 | 10 |
| Salt Cake | 10.0 | 10.0 | 7.5 | 7.5 | 7.5 |
| Anthracite | 1.8 | 1.8 | | | |
| Coal | | | | | |
| Graphite | | | 1.4 | 1.5 | 1.5 |
| Wt. % Fe₂O₃ | 0.325 | 0.325 | 0.333 | 0.333 | 0.333 |
| Wt. % FeO | 0.168 | 0.158 | 0.150 | 0.146 | 0.159 |
| Wt. % MnO₂ | 0.10 | 0.10 | 0.15 | 0.15 | 0.15 |
| ppm Se | 2.2 | 3.0 | 5.0 | 6.5 | 5.0 |
| Redox Ratio | 0.516 | 0.486 | 0.450 | 0.438 | 0.478 |
| % LTA | 74.26 | 75.20 | 75.89 | 75.39 | 75.03 |
| % LTC | 75.07 | 76.03 | 76.70 | 76.09 | 75.89 |
| Chrome x | 0.3057 | 0.3052 | 0.3054 | 0.3066 | 0.3050 |
| Chrome y | 0.3211 | 0.3203 | 0.3202 | 0.3212 | 0.3203 |
| Dominant | 504.5 | 501.0 | 501.6 | 509.6 | 501.0 |
| Wavelength | | | | | |
| Excitation | 1.5 | 1.6 | 1.5 | 1.2 | 1.7 |
| Purity, % | | | | | |
| % UV | 59.25 | 59.74 | 59.63 | 57.89 | 59.41 |
| % IR | 31.48 | 33.48 | 35.24 | 36.05 | 33.36 |
| % TSET | 51.01 | 52.58 | 53.83 | 53.94 | 52.41 |

Tables III and IV above did not incorporate any cobalt into glass of the invention. Cobalt oxide provides a blue component to the glass similar to the reduced iron and can be substituted for a portion of the reduced iron to produce the neutral grey color. Using cobalt in glass of the instant invention also tends to lower the dominant wavelength of the glass. The cobalt also tends to mask the yellow color of the oxidized portion of the iron. Table V below demonstrates the introduction of cobalt oxide to the glass. Selenium in the glass aids in neutralizing the blue color from both cobalt and the reduced form of iron oxide.

TABLE V

| | Example | Example | Example | Example | Example |
|---|---|---|---|---|---|
| | 11 | 12 | 13 | 14 | 15 |
| Salt Cake | 5.0 | 5.0 | 5.0 | 5.0 | 7.5 |
| Anthracite | 1.6 | 1.55 | 1.5 | 1.55 | |
| Coal | | | | | |
| Graphite | | | | | 1.7 |
| Wt. % Fe₂O₃ | 0.291 | 0.271 | 0.251 | 0.271 | 0.244 |
| Wt. % FeO | 0.140 | 0.121 | 0.129 | 0.135 | 0.111 |
| Wt. % MnO₂ | 0.15 | 0.15 | 0.15 | 0.15 | 0.15 |
| ppm Se | 2.6 | 3.0 | 2.0 | 2.3 | 4.0 |
| ppm Co | 8 | 9 | 4 | 4 | 10 |
| Redox Ratio | 0.480 | 0.447 | 0.514 | 0.498 | 0.454 |
| % LTA | 73.55 | 74.44 | 75.57 | 74.88 | 75.71 |
| % LTC | 74.33 | 75.02 | 76.24 | 75.64 | 76.52 |
| Chrome x | 0.3050 | 0.3069 | 0.3064 | 0.3055 | 0.3039 |
| Chrome y | 0.3189 | 0.3195 | 0.3201 | 0.3197 | 0.3164 |
| Dominant | 497.0 | 503.6 | 504.0 | 500.0 | 491.2 |
| Wavelength | | | | | |
| Excitation | 1.8 | 1.0 | 1.2 | 1.5 | 2.3 |
| Purity, % | | | | | |
| % UV | 59.79 | 59.80 | 61.77 | 60.87 | 63.55 |
| % IR | 31.48 | 33.48 | 35.24 | 36.05 | 33.36 |
| % TSET | 54.17 | 57.07 | 56.51 | 55.27 | 59.43 |

Table VI below illustrates the balance that needs to be obtained between the concentration of selenium to the concentration of cobalt in glass of the instant invention. Table VI uses a constant amount of salt cake together with a constant amount of graphite and constant amount of manganese dioxide. Note that the iron redox can vary slightly when the batch chemistry is constant.

TABLE VI

| | Example | Example | Example | Example | Example |
|---|---|---|---|---|---|
| | 16 | 17 | 18 | 19 | 20 |
| Salt Cake | 7.5 | 7.5 | 7.5 | 7.5 | 7.5 |
| Graphite | 1.7 | 1.7 | 1.7 | 1.7 | 1.7 |
| Wt. % Fe₂O₃ | 0.264 | 0.235 | 0.254 | 0.254 | 0.234 |
| Wt. % FeO | 0.129 | 0.110 | 0.115 | 0.135 | 0.115 |
| Wt. % MnO₂ | 0.15 | 0.15 | 0.15 | 0.15 | 0.15 |
| ppm Se | 3.3 | 3.7 | 4.0 | 3.0 | 4.7 |
| ppm Co | 10 | 10 | 11 | 8 | 10 |
| Redox Ratio | 0.488 | 0.469 | 0.452 | 0.531 | 0.492 |
| % LTA | 73.36 | 75.90 | 75.07 | 74.63 | 74.56 |
| % LTC | 74.14 | 76.73 | 75.86 | 75.51 | 75.21 |
| Chrome x | 0.3046 | 0.3037 | 0.3041 | 0.3043 | 0.3057 |
| Chrome y | 0.3179 | 0.3161 | 0.3167 | 0.3191 | 0.3180 |
| Dominant | 494.7 | 490.8 | 492.0 | 497.1 | 495.9 |
| Wavelength | | | | | |
| Excitation | 1.9 | 2.4 | 2.2 | 2.0 | 1.5 |
| Purity, % | | | | | |
| % UV | 60.70 | 64.39 | 62.44 | 61.71 | 62.12 |
| % IR | 39.97 | 44.99 | 43.73 | 38.59 | 43.65 |
| % TSET | 55.57 | 59.62 | 58.49 | 55.31 | 58.12 |

Table VII below illustrates the impact of increasing the selenium which drives the dominant wavelength lower and can increase the excitation purity.

TABLE VII

| | Example | Example | Example | Example | Example |
|---|---|---|---|---|---|
| | 21 | 22 | 23 | 24 | 25 |
| Salt Cake | 7.5 | 7.5 | 7.5 | 7.5 | 7.5 |
| Graphite | 1.8 | 1.7 | 1.8 | 1.7 | 1.5 |
| Wt. % Fe₂O₃ | 0.244 | 0.244 | 0.255 | 0.254 | 0.235 |
| Wt. % FeO | 0.124 | 0.107 | 0.115 | 0.123 | 0.111 |
| Wt. % MnO₂ | 0.15 | 0.15 | 0.15 | 0.15 | 0.15 |
| ppm Se | 4.2 | 6.5 | 6.0 | 5.0 | 6.5 |
| ppm Co | 12 | 10 | 12 | 10 | 15 |
| Redox Ratio | 0.508 | 0.438 | 0.451 | 0.483 | 0.472 |
| % LTA | 74.10 | 75.78 | 74.63 | 74.43 | 75.17 |
| % LTC | 74.99 | 76.55 | 75.42 | 75.26 | 75.80 |
| Chrome x | 0.3032 | 0.3043 | 0.3040 | 0.3039 | 0.3058 |
| Chrome y | 0.3165 | 0.3166 | 0.3165 | 0.3168 | 0.3177 |
| Dominant | 491.5 | 491.7 | 491.5 | 492.1 | 495.1 |
| Wavelength | | | | | |
| Excitation | 2.5 | 2.1 | 2.2 | 2.3 | 1.5 |
| Purity, % | | | | | |
| % UV | 63.17 | 62.91 | 62.60 | 62.18 | 63.26 |
| % IR | 41.28 | 45.95 | 43.78 | 41.53 | 44.95 |
| % TSET | 56.78 | 60.02 | 58.34 | 57.00 | 59.12 |

Table VIII below shows the extreme levels of cobalt and selenium in glass of the instant invention.

TABLE VIII

| | Example | Example | Example | Example | Example |
|---|---|---|---|---|---|
| | 26 | 27 | 28 | 29 | 30 |
| Salt Cake | 7.5 | 7.5 | 7.5 | 12.5 | 7.5 |
| Graphite | 1.5 | 1.5 | 1.5 | 2.0 | 1.6 |
| Wt. % Fe₂O₃ | 0.234 | 0.224 | 0.224 | 0.294 | 0.304 |
| Wt. % FeO | 0.116 | 0.113 | 0.109 | 0.120 | 0.141 |
| Wt. % MnO₂ | 0.15 | 0.15 | 0.15 | 0.15 | 0.15 |
| ppm Se | 6.1 | 5.8 | 6.5 | 12.4 | 11.4 |
| ppm Co | 13 | 13 | 13 | 10 | 9 |
| Redox Ratio | 0.496 | 0.504 | 0.486 | 0.408 | 0.463 |
| % LTA | 73.39 | 74.02 | 76.18 | 75.51 | 73.50 |
| % LTC | 74.03 | 74.75 | 76.96 | 76.35 | 74.37 |
| Chrome x | 0.3055 | 0.3046 | 0.3043 | 0.3041 | 0.3040 |
| Chrome y | 0.3175 | 0.3168 | 0.3168 | 0.3174 | 0.3183 |
| Dominant | 491.5 | 491.7 | 491.5 | 492.1 | 495.1 |
| Wavelength | | | | | |
| Excitation | 1.6 | 2.0 | 2.1 | 2.1 | 2.1 |
| Purity, % | | | | | |
| % UV | 61.89 | 63.50 | 64.69 | 60.70 | 58.73 |
| % IR | 43.33 | 44.27 | 45.40 | 42.27 | 37.31 |
| % TSET | 57.47 | 58.41 | 59.91 | 57.78 | 54.12 |

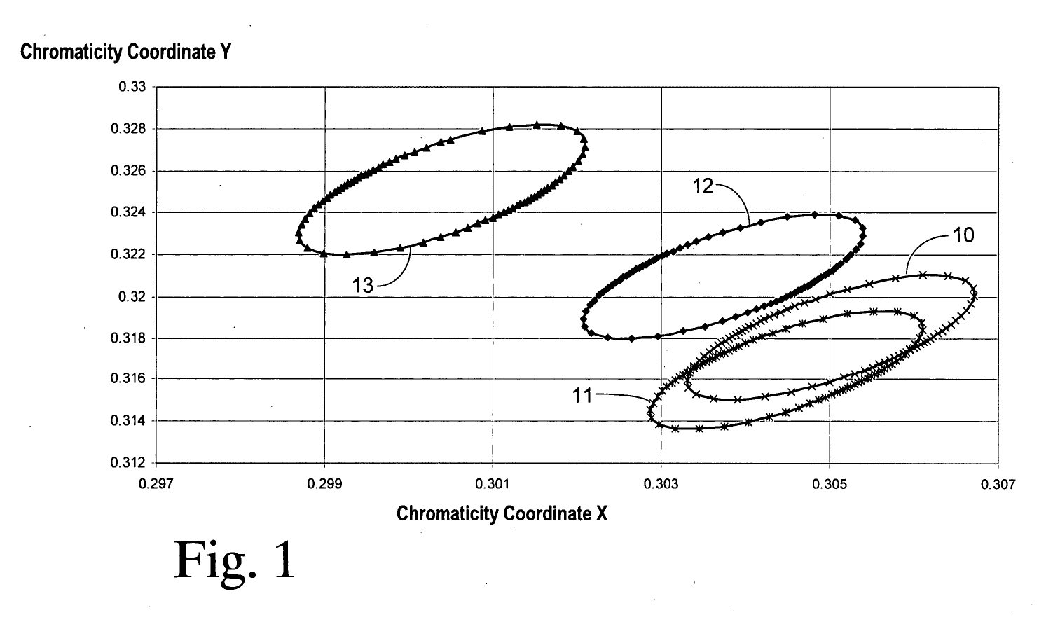

As can be seen from the examples above, the glass in accordance with the present invention provides for high transmittance, an improved infrared light absorption, and an improved ultraviolet absorption. FIG. 1 illustrates the chromaticity of the glass of the invention compared to prior art glass compositions. The chromaticity measurements are made using illuminant C with a 2° observer. An oval 10 representing the inventive neutral grey glass has a chromaticity very close to an oval 11 representing a typical clear glass. More specifically, the color space of oval 10 is substantially contained within a parallelogram bounded by the following x and y chromaticity coordinates: (0.304, 0.314); (0.3075, 0.3205); (0.3065, 0.323); and (0.303, 0.317). An oval 12 represents the green chromaticity of a typical tinted automotive glass, and an oval 13 represents the darker green chromaticity of a typical solar-tint automotive glass. The desirably chromaticity is achieved even while obtaining an LTA of 75% and an infrared transmission of 40%.

What is claimed is:

1. A colored glass having a base and a colorant, wherein composition of the colorant by weight of the colored glass comprises:
0.22 to 0.36 wt. % Fe₂O₃;
0.10 to 0.18 wt. % FeO;
0.1 to 0.5 wt. % MnO₂;
1.5 to 13 ppm selenium; and
0 to 15 ppm Cobalt;
wherein a redox ratio of the weight of FeO to the total weight of iron is in a range of about 0.35 to up to less than about 0.60; and
wherein the colored glass at 4 mm. control thickness has a light transmittance using illuminant A in a range of 74 to 77%, an ultraviolet transmittance in a range of 57 to 65%, an infrared transmittance in a range of 30 to 46%, a total solar energy transmittance in a range of 50 to 61%, and a color using illuminant C substantially within a parallelogram bounded by chromaticity coordinates (0.304, 0.314), (0.3075, 0.3205), (0.3065, 0.323), and (0.303, 0.317).

2. The colored glass of claim 1 wherein said redox ratio of the weight of FeO to the total weight of iron is in a range of about 0.45 to about 0.55.

3. The colored glass of claim 1 wherein the composition of the base by weight of the colored glass includes 1.3 to 1.8 wt. % anthracite coal.

4. The colored glass of claim 1 wherein the composition of the base by weight of the colored glass includes 1.4 to 2.0 wt. % graphite.

5. The colored glass of claim 1 wherein the dominant wavelength is in a range of 490.8 to 509.6 nanometers.
